(19) United States
(12) Patent Application Publication
(10) Pub. No.: US 2016/0059343 A1
(43) Pub. Date: Mar. 3, 2016

(54) METHOD FOR IMPROVING THE WELDABILITY OF HOT STAMPING PARTS

(71) Applicant: HYUNDAI HYSCO CO., LTD., Ulsan (KR)

(72) Inventors: Seung-Man NAM, Dangjin-si, Chungcheongnam-do (KR); Young-Chul PARK, Seoul (KR)

(21) Appl. No.: 14/356,693

(22) PCT Filed: May 20, 2013
(86) PCT No.: PCT/KR2013/004392

§ 371 Date: May 7, 2014

(30) Foreign Application Priority Data
May 13, 2013 (KR) 10-2013-0053887

(51) Int. Cl. B23K 11/16; B23K 11/14; B23K 11/34

(52) U.S. Cl. CPC B23K 11/163; B23K 11/34; B23K 11/14; B23K 2203/04

(57) ABSTRACT

A method for improving the weldability of hot stamping parts improving weldability of hot stamping parts with degraded weldability due to surface oxides is provided.

In accordance with an embodiment of the present invention, a method for improving the weldability of hot stamping parts comprises: selecting a welding region in a hot stamping part; removing surface oxide of the welding region; and performing welding on a welding region on a hot stamping part with surface oxide removed.

### TECHNICAL FIELD

The present invention relates to a method for improving the weldability of hot stamping parts, and more particularly a method for improving the weldability of hot stamping parts improving the weldability of hot stamping parts with Al plating having low weldability due to surface oxides.

### BACKGROUND ART

Hot stamping technology is conducted at high temperatures contrary to prior press forming, which is conducted at cold states.

Since elongation of materials greatly increases at high temperatures, there are advantages of having no special constraints in formability and super high strength from effect of heat treatment.

But, since hot stamping is conducted in high temperatures of 900° C. or higher, safety of materials at high temperatures is very important, and plated steel sheets are normally used for this reason.

Currently, Al—Si plated steel sheets are typically used for materials for hot stamping, and recently, research to use GA plated steel sheets, with lower prices, is being actively conducted, but many limitations exist due to technological limitations such as evaporation of plated layers at high temperatures, generation of oxide films, etc.

But, in the case of hot stamping parts using Al—Si plated steel sheets, problems of surface weldablity degrading due surface oxides exist.

FIG. 1 is an exemplary drawing showing a center-pillar of an automobile as a hot stamping part. Illustrated center-pillar is an Al—Si plated hot stamping part, and a number of nuts are welded at each set positions (P) in the center-pillar (10). And this nut welding is conducted using a projection welding method.

FIG. 2 is a simplified drawing showing an image of a nut welding through a center-pillar of an automobile as a hot stamping part using projection welding. As shown, a hot stamping part, i.e. a center-pillar (10) is placed between a pair of welding electrodes (21, 23) facing each other in a projection welding device (20), and current is applied with a nut (N) inserted. And thus a resistance welding is performed between a hot stamping part and a nut.

But, situations where nuts welded with this method easily detaching occurred frequently. And as a reason for this faulty welding, the fact that surface oxides of Al—Si plated hot stamping parts degrade surface weldability was confirmed.

Korean Patent No. 760152 (published on Sep. 18, 2007) is a related prior art, and a method for manufacturing high strength automobile parts from zinc plated steel sheets by using hot stamping is posted in the prior document.

### DISCLOSURE

### Technical Problem

The present invention provides a method for improving the weldability of hot stamping parts that may improve the weldability of hot stamping parts with degraded weldability of nuts due to surface oxides.

### Technical Solution

In accordance with an embodiment of the present invention, a method for improving the weldability of hot stamping parts comprising: selecting a welding region in a hot stamping part; removing surface oxide of the welding region; and performing welding on a welding region on a hot stamping part with the surface oxide removed is provided.

Also, in accordance with an embodiment of the present invention, a method for improving the weldability of hot stamping parts comprising: selecting a welding region in a hot stamping part; removing surface oxide of the welding region; removing remnant of oxide layer and portion of plating layer of the welding region; and performing welding on a welding region on a hot stamping part with remnant of oxide layer and portion of plating layer removed is provided.

Also, in accordance with an embodiment of the present invention, a method for improving the weldability of hot stamping parts comprising: selecting a welding region in a hot stamping part; removing surface oxide of the welding region; removing remnant of oxide layer and portion of plating layer of the welding region; removing entire plating layer of the welding region; and performing welding on a welding region on a hot stamping part with remnant of oxide layer and entire plating layer removed is provided.

The hot stamping part is a material of Al—Si plated steel sheet.

The hot stamping part is a material of Al—Si plated steel sheet and welding may be performed on the welding region using projection welding.

The hot stamping part is a material of Al—Si plated steel sheet and welding may be performed on the welding region using projection welding, and a grinder may be used or laser grinder may be used when removing surface oxide and removing remnant of oxide layer and portion of plating layer and removing entire plating layer.

### Advantageous Effects

In accordance with an embodiment of the present invention, when welding (i.e. nut welding) is required on hot stamping parts using Al—Si plated steel sheets, removing, in advance, sectional oxide layer and/or plating layer corresponding to a region to be welded may be performed and improve weldability of hot stamping parts.

Grinder devices may be used or laser devices may be used to remove sectional oxide and/or plating layer corresponding to welding region of hot stamping parts.

Especially, when removing only sectional surface oxide layer corresponding to a welding region of hot stamping parts before welding (i.e. nut welding), improvement of weldability is small but plating layer remains as is and high corrosion resistance is obtainable.

This method for improving the weldability of hot stamping parts may be applied to operation of hot stamping parts (or specific portion of the corresponding part) requiring relatively high corrosion resistance.

Also, when removing a section of oxide layer and portion of plating layer corresponding to a welding region of these hot stamping parts, effect of high improvement of weldability may appear while obtaining corrosion resistance at a certain level.

Also, when removing a section of oxide layer and entire plating layer corresponding to a welding region of hot stamping parts, effect of improvement of weldability may be maximized but corrosion resistance relatively degrades.

This method for improving the weldability of hot stamping parts may be applied to hot stamping parts (or specific portion of the corresponding part) requiring relatively low corrosion resistance.

### DESCRIPTION OF DRAWINGS

FIG. 1 is a simplified exemplary drawing showing a center-pillar of an automobile as a hot stamping part.

FIG. 2 is a simplified drawing showing an image of a nut welding on a center-pillar using projection welding.

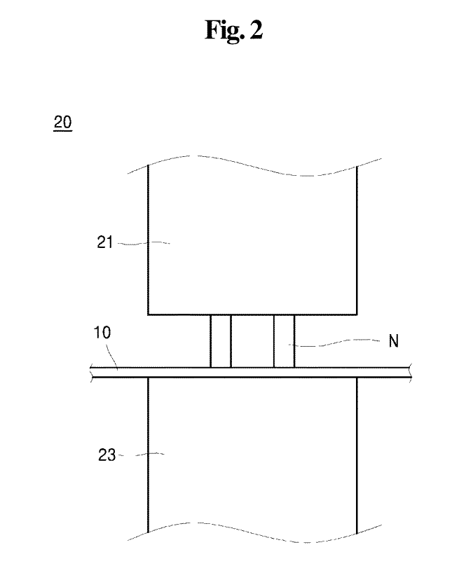

FIG. 3 is a cross sectional view of a hot stamping part according to an embodiment of the present invention.

FIG. 4 is a flow chart of a method for improving the weldability of hot stamping parts according to example 1 of the present invention.

FIG. 5 is a cross sectional view showing an image with only surface oxide layer removed through a method for improving the weldability of hot stamping parts according to example 1 of the present invention.

FIG. 6 is a flow chart of a method for improving the weldability of hot stamping parts according to example 2 of the present invention.

FIG. 7 is a cross sectional view showing an image with portion of surface oxide layer and plating layer removed through a method for improving the weldability of hot stamping parts according to example 2 of the present invention.

FIG. 8 is a flow chart of a method for improving the weldability of hot stamping parts according to example 3 of the present invention.

FIG. 9 is a cross sectional view showing an image with entire surface oxide layer and plating layer removed through a method for improving the weldability of hot stamping parts according to example 3 of the present invention.

### BEST MODE

The terms and vocabulary used in the descriptions and claims of the present invention should not be interpreted limited to its general or its literal meanings, and should be interpreted as meanings and concepts corresponding to the technical idea of the present invention based on the principle that an inventor may appropriately define the notion of terms to describe the invention in the best way possible.

Also, examples described in the descriptions and configurations illustrated in the drawings described herein are only one of the preferred embodiments, and does not represent all of the technical ideas of the present invention, and therefore it should be understood that various modifications, variations and alterations may be made without departing from the scope of the invention.

Hot stamping technology is conducted at high temperatures contrary to prior press forming, which is conducted at a cold state. Since elongation of materials greatly increases at high temperatures, there are advantages of having no special constraints in formability and super high strength from effect of heat treatment. But, since hot stamping is conducted in high temperatures of 900° C. or higher, safety of materials at high temperature is very important, and plated steel sheets are normally used for this reason.

But, in the case of hot stamping parts using Al—Si plated steel sheets, problems of surface weldablity degrading due to surface oxides exist.

A method for improving the weldability of hot stamping parts in accordance with an embodiment of the present invention is provided to solve the described problems.

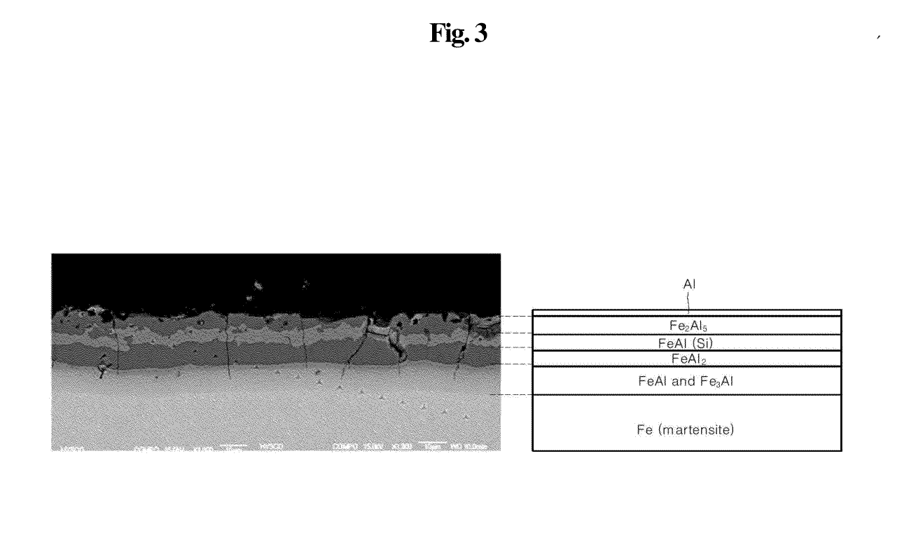

FIG. 3 is a cross sectional view of a hot stamping part according to an embodiment of the present invention.

Referring to FIG. 3, a hot stamping part with Al—Si plated steel sheet as its material, from the bottom going up, Fe(martensite), FeAl and Fe3Al, FeAl2, FeAl(Si), Fe2Al5 is laminated, and a Al surface oxide layer with about 5˜100 nm thickness is formed on the surface. But, the surface oxide layer degrades the weldability of hot stamping parts with Al—Si plated steel sheet as its material.

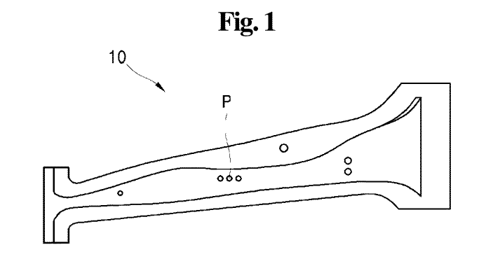

Specifically, a center-pillar (10 of FIG. 1) among hot stamping parts with Al—Si plated steel sheet its material is used as an example.

Center-pillar is a part for automobiles, and a number of nuts are combined through projection welding for each interior set position. But, surface oxide layer, same as above, exist on the surface of a center-pillar, where Al—Si plated steel sheet is provided through a hot stamping process, and thus situations where welded nuts easily detaching occur frequently.

Hereinafter, a method for improving the weldability of hot stamping parts in accordance with an embodiment of the present invention is described in detail with reference to accompanying drawings.

### Example 1

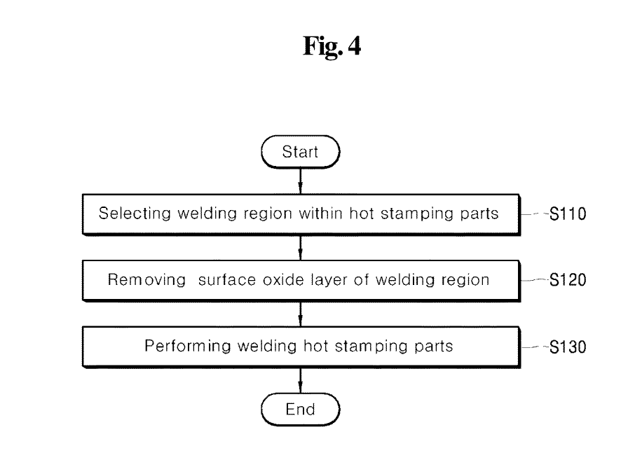

FIG. 4 is a flow chart of a method for improving the weldability of hot stamping parts.

A method for improving the weldability of hot stamping parts in accordance with example 1 of the present invention may be achieved by carrying out selecting welding region step (S110), removing surface oxide layer step (S120), and welding step (S130).

Selecting welding region step (S110) is a step where a welding region on a hot stamping part manufactured with an Al—Si plated steel sheet is selected.

For a detailed example, a center-pillar (10 of FIG. 1), which is an example of a hot stamping part, shown in FIG. 1 may be referred.

Positions (P) where a number of nuts (not shown) are to be welded inside a center-pillar (10 of FIG. 1) are determined, and a welding region may be selected limited to a surrounding of these areas.

But, this welding region may differ according to type, size, etc. of a hot stamping part, and may be selected in different shapes according to characteristics of the corresponding part.

But in the case of hot stamping parts with Al—Si plated steel sheets as its material, Al oxide layer (this is referred to as “surface oxide layer”) is formed on the surface, and this surface oxide layer is a reason for degrading weldability of parts. Therefore, this is removed in the removing surface oxide layer step (S120) described below.

Removing surface oxide layer step (S120) is a step removing surface oxide layer of a welding region of a hot stamping part.

In this step, a method mechanically removing surface oxide layer using grinders may be used.

Also, surface oxide layer may be removed using laser devices.

Since grinding methods using grinders and grinding methods using laser devices are well known technologies, additional descriptions will be skipped.

Through the removing surface oxide layer step (S120), Al oxide layer formed on a surface of hot stamping parts with Al—Si plated steel sheets as its material is effectively removed, and thickness of surface oxide layer is formed between about 5 to 100 nm.

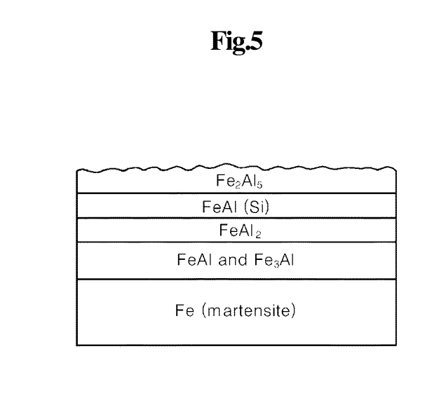

A simplified cross sectional structure of a hot stamping part with the surface oxide layer removed may be identified referring to FIG. 5.

As shown in FIG. 5, surface oxide layer of a hot stamping part is removed, and only Fe(martensite), FeAl and Fe₃Al, FeAl₂, FeAl(Si), Fe₂Al₅ is shown in the cross sectional view.

Welding step (S130) is a step where welding is performed on a welding region of a hot stamping part with surface oxide layer removed from the previous step.

For a detailed example of a hot stamping part, when referring to a center-pillar (10 of FIG. 1) shown in FIG. 1, after removing surface oxide layer through a position (P) i.e. a welding region, where a number of nuts are to be welded through an interior of a center-pillar, projection welding is performed between a center-pillar and a nut.

Likewise, by the described method, and after removing only surface oxide layer corresponding to a welding region of a hot stamping part, even though the method for performing welding has a relatively low effect of improvement of weldability compared to examples that will be described below, relatively high corrosion resistance may be obtained.

Therefore, a method for improving the weldability of hot stamping parts according to above described example 1 may be applied to operation of hot stamping parts (or a specific portion of the corresponding part) requiring relatively high corrosion resistance.

### Example 2

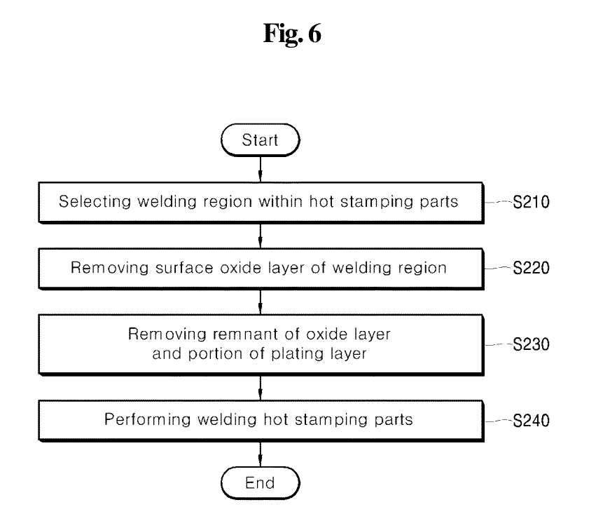

FIG. 6 is a flow chart of a method for improving the weldability of hot stamping parts according to example 2 of the present invention.

A method for improving the weldability of hot stamping parts in accordance with example 2 of the present invention may be achieved by carrying out selecting welding region step (S210), removing surface oxide layer step (S220), removing portion of oxide layer and plating layer step (S230), and welding step (S240).

Selecting welding region step (S210) is a step where a welding region on a hot stamping part manufactured with an Al—Si plated steel sheet is selected.

For a detailed example, a center-pillar (10 of FIG. 1), which is an example of a hot stamping part, shown in FIG. 1 may be referred. Positions (P) where a number of nuts (not shown) are to be welded is determined inside a center-pillar (10 of FIG. 1), and a welding region is selected limited selected limited to a surrounding of these areas.

This selecting welding region step (S210) is identical to the selecting welding region step (S110 of FIG. 4) of example 1 of the present invention described above, and repetitive description is skipped.

Removing surface oxide layer step (S220) is a step removing surface oxide layer of a welding region of a hot stamping part.

In this step, Al oxide layer formed on a surface of hot stamping parts with Al—Si plated steel sheets as its material is removed, and thickness of surface oxide layer is formed between about 5 to 100 nm.

Removing portion of oxide layer and plating layer step (S230) is a step performed with/or in sequence with the described removing surface oxide layer step (S220).

These removing surface oxide layer step (S220) and removing portion of oxide layer and plating layer step (S230) may use grinders or use laser devices.

And remaining portion of oxide layer (FeAl₂, FeAl(Si)) formed below a surface oxide layer, and portions of plating layer of FeAl and Fe₃Al formed below it may be removed through this step.

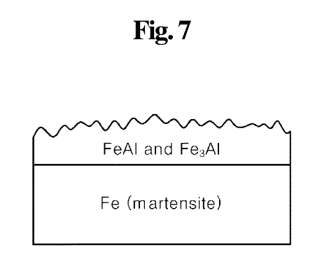

A simplified cross sectional structure of a hot stamping part with surface oxide layer, a portion of oxide layer and plating layer removed may be identified referring FIG. 7. That is, Fe(martensite), and only plating layer of FeAl and Fe₃Al exist from the cross sectional view of the illustrated hot stamping part.

Welding step (S240) is a step where welding is performed on a welding region of a hot stamping part with surface oxide layer, a portion of oxide layer and plating layer removed from the previous step.

According to the method of improving the weldability performed through the described steps, as entire oxide layer and a portion of plating layer is removed, high effect of improving weldability may be obtained while obtaining corrosion resistance.

### Example 3

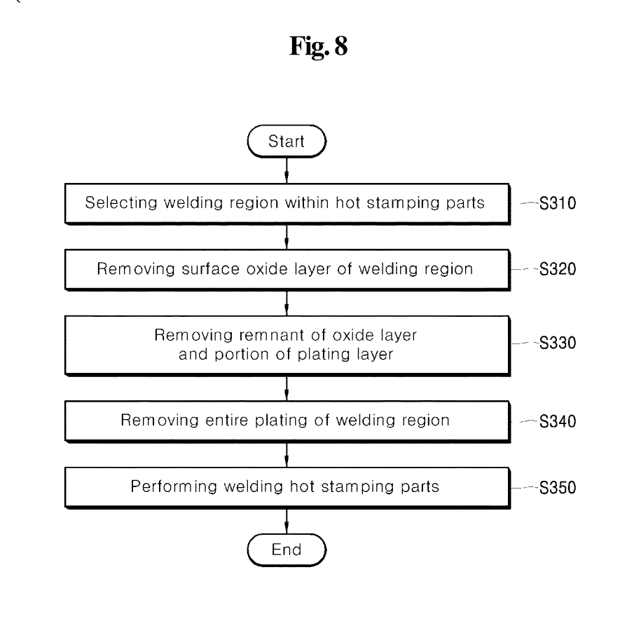

FIG. 8 is a flow chart of a method for improving the weldability of hot stamping parts according to example 3 of the present invention

A method for improving the weldability of hot stamping parts in accordance with example 3 of the present invention may be achieved by carrying out selecting welding region step (S310), removing surface oxide layer step (S320), removing portion of oxide layer and plating layer step (S330), removing entire plating layer step (S340), and welding step (S350).

Selecting welding region step (S310) is a step where a welding region on a hot stamping part manufactured with Al—Si plated steel sheet is selected.

For a detailed example, a center-pillar (10 of FIG. 1), which is an example of a hot stamping part, shown in FIG. 1 may be referred. Positions (P) where a number of nuts (not shown) are to be welded is determined inside a center-pillar (10 of FIG. 1), and a welding region is selected limited selected limited to a surrounding of these areas.

This selecting welding region step (S310) is identical to a selecting welding region steps of example 1 and 2 of the present invention described above, and repetitive description is skipped.

Removing surface oxide layer step (S320) is a step removing surface oxide layer of a welding region of a hot stamping part. In this step, Al oxide layer formed on a surface of hot stamping parts with Al—Si plated steel sheets as its material is removed, and thickness of surface oxide layer is formed between about 5 to 100 nm.

Removing portion of oxide layer and plating layer step (S330) is a step performed with/or in sequence with the described removing surface oxide layer step (S320).

Removing entire plating layer step (S340), contrary to example 2 described above, is a step entirely removing remnant plating layer on a welding region of a hot stamping part. Through this step, surface oxide layer (Al oxide layer), and rest of the oxide layer (FeAl₂, FeAl(Si)) formed below it, and also, plating layer of FeAl and Fe₃Al is entirely removed.

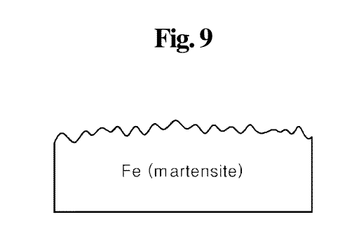

A simplified cross sectional structure of a hot stamping part after removing entire plating layer step (S340) is performed may be identified through FIG. 9. Referring to FIG. 9, only Fe (martensite) is left.

Welding step (S350) is a step where welding is performed on a welding region of a hot stamping part with only Fe (martensite) left.

As such, when entire oxide layer and a portion of plating layer is removed corresponding to a welding region of a hot stamping part according to the described method, effect of improving weldability may be maximized but corrosion resistance relatively degrades.

Therefore, in the case of method for improving the weldability of hot stamping parts according to the described example 3, may be applied to operation of hot stamping parts (or a specific portion of the corresponding parts) requiring relatively low corrosion resistance.

As described above, in accordance with an embodiment of the present invention, when welding (i.e. nut welding) is required on a hot stamping part using Al—Si plated steel sheet, weldability of hot stamping parts may be improved by performing, in advance, sectional oxide layer and/or plating layer removal of a part to be welded.

And for performing sectional oxide layer and/or plating layer removal of welding region of hot stamping parts, grinder devices may be used or laser devices may be used.

Specifically, when only sectional surface oxide layer is removed corresponding to a welding region of hot stamping parts before welding (i.e. nut welding), effect of improvement of weldability is small but plating layer remain as is and may obtain high corrosion resistance.

This method for improving the weldability of hot stamping parts may be applied for operation of hot stamping part (or specific portion of the corresponding part) requiring relatively high corrosion resistance.

Also, when sectional oxide layer and portion of plating layer is removed corresponding to a welding region of hot stamping parts, effect of high improvement of weldability may be obtainable while obtaining corrosion resistance at a certain level.

Also, when removing oxide layer partially and plating layer entirely corresponding to welding region of hot stamping parts, effect of improvement of weldability may be maximized but corrosion resistance relatively degrades.

This method for improving the weldability of hot stamping parts may be applied to hot stamping parts (or specific portion of the corresponding part) requiring relatively low corrosion resistance.

A method for improving the weldability of hot stamping parts according to a preferable embodiment of the present invention has been described herein.

The described examples are provided by way of examples only and the present invention is not limited thereto, and the scope of the present invention should be defined by the appended claims rather than the detailed descriptions described above. And it should be understood that all modifications and alterations that can be made from the meanings and the scope of the appended claims and equivalents thereof is within the scope of the present invention.

1. A method for improving the weldability of hot stamping parts, comprising:
selecting a welding region in a hot stamping part;
removing surface oxide layer of the welding region; and
performing welding on a welding region on a hot stamping part with the surface oxide removed.

2. A method for improving the weldability of hot stamping parts according to claim 1, wherein the hot stamping part is a material of Al—Si plated steel sheet.

3. A method for improving the weldability of hot stamping parts according to claim 1, wherein the hot stamping part is a material of Al—Si plated steel sheet and welding is performed on the welding region using projection welding.

4. A method for improving the weldability of hot stamping parts according to claim 1, wherein the hot stamping part is a material of Al—Si plated steel sheet and welding is performed on the welding region using projection welding, and a grinder is used or a laser grinder is used when removing surface oxide.

5. A method for improving the weldability of hot stamping parts, comprising:
selecting a welding region in a hot stamping part;
removing surface oxide layer of the welding region;
removing remnant of oxide layer and portion of plating layer of the welding region; and
performing welding on a welding region on a hot stamping part with remnant of oxide layer and portion of plating layer removed.

6. A method for improving the weldability of hot stamping parts according to claim 5, wherein the hot stamping part is a material of Al—Si plated steel sheet.

7. A method for improving the weldability of hot stamping parts according to claim 5, wherein the hot stamping part is a material of Al—Si plated steel sheet and welding is performed on the welding region using projection welding.

8. A method for improving the weldability of hot stamping parts according to claim 5, wherein the hot stamping part is a material of Al—Si plated steel sheet and welding is performed on the welding region using projection welding, and a grinder is used or laser grinder is used when removing surface oxide layer and removing remnant of oxide layer and portion of plating layer.

9. A method for improving the weldability of hot stamping parts, comprising:
selecting a welding region in a hot stamping part;
removing surface oxide of the welding region;
removing remnant of oxide layer and portion of plating layer of the welding region;
removing entire plating layer of the welding region; and
performing welding on a welding region on a hot stamping part with remnant of oxide layer and entire plating layer removed.

10. A method for improving the weldability of hot stamping parts according to claim 9, wherein the hot stamping part is a material of Al—Si plated steel sheet.

11. A method for improving the weldability of hot stamping parts according to claim 9, wherein the hot stamping part is a material of Al—Si plated steel sheet and welding is performed on the welding region using projection welding.

12. A method for improving the weldability of hot stamping parts according to claim 5, wherein the hot stamping part is a material of Al—Si plated steel sheet and welding is performed on the welding region using projection welding, and a grinder is used or laser grinder is used when removing surface oxide layer and removing remnant of oxide layer and portion of plating layer and removing entire plating layer.
